(19) United States
(12) Patent Application Publication
(10) Pub. No.: US 2018/0199116 A1
(43) Pub. Date: Jul. 12, 2018

(54) METHOD AND APPARATUS FOR IP MULTICAST GROUPING

(71) Applicant: THOMSON Licensing, Issy-les-Moulineaux (FR)

(72) Inventors: Tao ZHOU, BEIJING (CN); Yiming GE, BEIJING (CN); Ming PAN, BEIJING (CN)

(21) Appl. No.: 15/741,254

(22) PCT Filed: Jun. 30, 2015
(86) PCT No.: PCT/CN2015/082755

§ 371 Date: Dec. 30, 2017

(51) Int. Cl. H04N 21/6405; H04N 21/61; H04N 21/643; H04L 29/06; H04L 12/24

(52) U.S. Cl. CPC H04N 21/6405; H04N 21/6125; H04L 41/0213; H04L 65/4076; H04L 65/1026; H04N 21/64322

(57) ABSTRACT

In some cases, an IPTV client may send multiple IGMP Report/Join requests to an IPTV gateway, primarily due to a system or software failure. This may flood the IPTV client device with unwanted streaming data. A method and an apparatus for managing Internet Group Management Protocol (IGMP) multicast groups of IPTV service are suggested. The method comprises receiving a request from an IPTV client device for joining a new IGMP multicast group of IPTV service; and adjusting IGMP multicast groups of the IPTV client device according to a preset rule as a function of the number of the IGMP multicast groups which are joined by the IPTV client device over a preset value. According to the disclosure, only a preset number of IGMP groups are allowed for an IPTV client device, which can reduce the risk of streaming data flooding the system.

### TECHNICAL FIELD

The present disclosure generally relates to networking. In particular, the present disclosure relates to a method and an apparatus for IP (Internet Protocol) multicast grouping.

### BACKGROUND

The Internet Group Management Protocol (IGMP) is a communications protocol used by hosts and adjacent routers on IP networks to establish multicast group memberships. IGMP can be used for one-to-many networking applications, such as online streaming video and audio.

In a context of internet protocol television (IPTV), one multicast group stands for one TV channel. An IPTV client, such as a set top box (STB), will normally send out or respond to one multicast group so that only one channel can be watched on a TV set at any given time. While in some cases, an IPTV client may send multiple IGMP Report/Join requests to an IPTV gateway, primarily due to a system or software failure. The IPTV gateway then will associate all multicast group information to this IPTV client according to standard IGMP protocol definitions, and send too much video streaming data of these groups to the IPTV client. The large amount of video streaming data may flood the IPTV client with unwanted streaming data.

### SUMMARY

According to an exemplary aspect of the disclosure, there is provided a method to manage multicast groups of streamed multimedia data. The method comprises: receiving a request from a client device to join a new multicast group of a streamed multimedia data service; and adjusting multicast groups of the client device according to a preset condition as determined by a number of the multicast groups which were previously joined by the client device over a value.

In an exemplary embodiment, the streamed multimedia data service is an Internet Protocol Television (IPTV) service and the method is for managing a multicast grouping of the IPTV service according to an Internet Group Management Protocol (IGMP).

In an exemplary embodiment, the adjustment further comprises associating the IP(Internet Protocol)/MAC(Media Access Control) address of the client device with the IP/MAC address of the new multicast group if the number of said multicast groups is not equal to the value.

In an exemplary embodiment, the adjustment further comprises ignoring said request if the number of said multicast groups is equal to the value.

In an exemplary embodiment, the adjustment further comprises dropping one or more multicast groups which are joined by the client device and associating the IP/MAC address of the client device with the IP/MAC address of the new multicast group if the number of said multicast groups is equal to the value.

In an exemplary embodiment, the method further comprises dropping an oldest one of said multicast groups.

In an exemplary embodiment, the adjustment is implemented by definitions in the Simple Network Management Protocol (SNMP).

According to an exemplary aspect of the disclosure, there is provided a device to manage multicast groups of streamed multimedia data. The device comprises a first interface to communicate with a head-end device of multimedia data service over a first network and a second interface to communicate with at least one client devices over a second network, for delivering at least one multicast group of multimedia data service from the head-end device to the client device. The device further comprises a controller comprising: a receiving unit to receive a request from one of the at least one client devices for joining a new multicast group of multimedia data service; and an adjustment unit to adjust multicast groups of said client device according to a preset condition as determined by a number of the multicast groups which were previously joined by the client device over a value.

In an exemplary embodiment, the device is a gateway for delivering data of an Internet Protocol Television (IPTV) service to the at least one client devices according to an Internet Group Management Protocol (IGMP).

In an exemplary embodiment, the adjustment unit associates the IP/MAC address of said client device with the IP/MAC address of the new multicast group if the number of said multicast groups is not equal to the value.

In an exemplary embodiment, the adjustment unit ignores said request if the number of said multicast groups is equal to the value.

In an exemplary embodiment, the adjustment unit drops one or more IGMP multicast groups which are joined by said client device and associates the IP/MAC address of said client device with the IP/MAC address of the new multicast group if the number of said multicast groups is equal to the value.

In an exemplary embodiment, the adjustment unit drops an oldest one of said multicast groups.

In an exemplary embodiment, the first network is a cable network.

In an exemplary embodiment, the second network is a wireless network.

According to an exemplary embodiment of the disclosure, only a preset number of IGMP groups are allowed for an IPTV client device, which will reduce the risk of streaming data flooding the system.

It is to be understood that more aspects and advantages of the disclosure will be found in the following detailed description of the present disclosure.

### BRIEF DESCRIPTION OF THE DRAWINGS

The accompanying drawings are included to provide further understanding of the embodiments of the disclosure together with the description which serves to explain the principle of the embodiments. The disclosure is not limited to the embodiments.

In the drawings:

FIG. 1 is an exemplary diagram showing the structure of a cable IPTV network;

FIG. 2 is an exemplary diagram showing the process of a CPE joining and unsubscribing to a cable gateway for a multicast TV program in the cable IPTV network shown in FIG. 1;

FIG. 3 is an exemplary diagram showing the process of a CPE joining and unsubscribing to a cable gateway for several multicast TV programs at the same time in the cable IPTV network shown in FIG. 1;

FIG. 4 is an exemplary flow chart showing the method of managing IP multicast groups of IPTV service according to an embodiment of the disclosure; and

FIG. 5 is an exemplary block diagram showing a gateway device of managing IP multicast groups of IPTV service according to an embodiment of the disclosure.

### DETAILED DESCRIPTION

An embodiment of the present disclosure will now be described in detail in conjunction with the drawings. In the following description, some detailed descriptions of known functions and configurations may be omitted for conciseness.

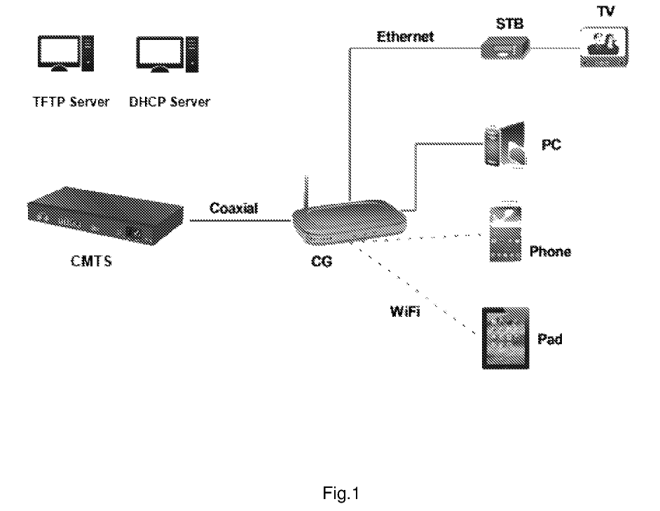

FIG. 1 is an exemplary diagram showing the structure of a cable IPTV network.

In the cable IPTV network shown in FIG. 1, a multicast streaming is carried out on a coaxial wire from a head-end device to a cable gateway (CG). In the network of FIG. 1, the head-end device is a Cable Modem Terminal System (CMTS) device, which acts as a layer-2 or layer-3 equipment that can be used by cable operators to provide data or voice service to their cable subscribers. The cable gateway here is used to deliver digital data or VoIP (Voice over Internet Protocol) data over a cable network, which can be a typical cable modem device without WiFi capability or a cable gateway with WiFi capability. In the network of FIG. 1, the cable gateway has the WiFi capability. The cable gateway will deliver multicast streams of IPTV to underlying devices, i.e., CPEs (Customer premises equipment). The CPE can be a STB, a tablet (Pad), a PC or a smart phone, etc. In this case, the cable gateway acts as an IGMP router for forwarding the multicast data packets from the upper layer network to a CPE which joins a certain multicast address. The underlying devices all act as IGMP clients, which should support IGMP protocol to join a certain multicast group maintained in the cable gateway in order to play multicast streams decoded in various video formats, such as MPEG(Moving Pictures Expert Group)—2 (ISO/IEC 13818), H.264/MPEG-4 Part 10, Advanced Video Coding and HEVC (High Efficiency Video Coding.

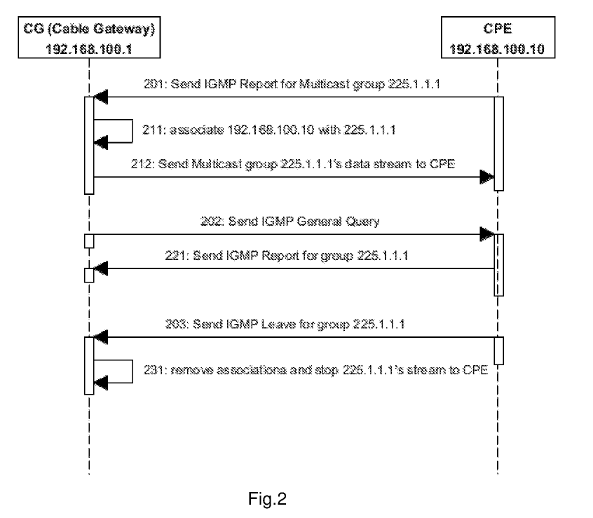

FIG. 2 is an exemplary diagram showing the process of a CPE joining and unsubscribing to a cable gateway for a multicast TV program in the cable IPTV network shown in FIG. 1.

In practice, an IPTV operator will restrict, for business considerations, the total number of IPTV clients and/or the total number of IPTV channels that one cable gateway can access at the same time. The IPTV operator can be a multi-system operator (MSO) which for example provides network services, in addition to the IPTV service, on the cable network. Information for the CPE joining and unsubscribing is maintained by IGMP protocol.

In the example shown in FIG. 2, a cable gateway and a CPE can have the IP address 192.168.100.1 and 192.168.100.10, respectively.

At the step 201, the CPE will send an IGMP Join/Report message to the cable gateway to subscribe to a multicast group, for example, 225.1.1.1.

At the step 211, the cable gateway will add an association between the IP or MAC address of the CPE and that of the requesting multicast group (225.1.1.1 in this example) internally, and then at the step 212 send streaming video data for the group 225.1.1.1 to the CPE. In an example of the association, the cable gateway can maintain a map like data structure or look up table, with the key being the IP or MAC address of the CPE and the value being a list of multicast group IP address. If there is no such key existing in the map, the cable gateway will create a new map entry with key/value as described above. If there is already one key existing in the map, the cable gateway will get the list associated with the key from the map, add the IP address of the new multicast group into the list, and put the updated list back to map.

At the step 202, the cable gateway will periodically send an IGMP General Query message to the CPE, asking if there are any multicast groups that the CPE can subscribe to.

At the step 221, the CPE will send an IGMP report message for the multicast group 225.1.1.1 back to the gateway as a response to the query message.

If the CPE does not want to access the multicast program on the multicast group 225.1.1.1 anymore, at the step 203, the CPE sends out an IGMP leave message to the cable gateway to unsubscribe to this multicast group. Then at the step 231 the gateway will remove the association between the IP addresses 192.168.100.10 and 225.1.1.1, and stop sending video data to the CPE anymore.

It can be appreciated that if the CPE fails to respond to the IGMP General Query messages sent by the gateway for certain times, for example, due to sudden power off, at the step 231 the cable gateway will also remove the association internally and stop sending the video data to the CPE.

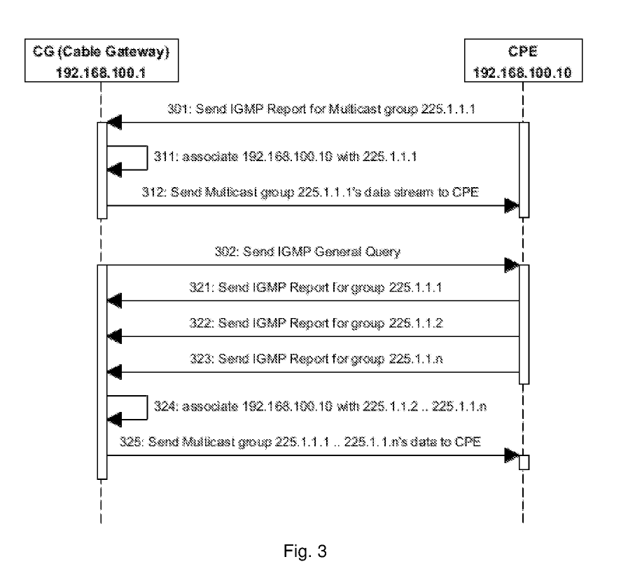

FIG. 3 is an exemplary diagram showing the process of a CPE joining and unsubscribing to a cable gateway for several multicast TV programs at the same time in the cable IPTV network shown in FIG. 1.

Similarly, a cable gateway and a CPE in FIG. 3 can have the IP address 192.168.100.1 and 192.168.100.10, respectively.

At the step 301, the CPE will send an IGMP Join/Report message to the cable gateway to subscribe to a multicast group, for example, 225.1.1.1.

At the step 311, the cable gateway will add association between the IP address of the CPE and that of the requesting multicast group (225.1.1.1 in this example) internally, and then at the step 312 send streaming video data for the group 225.1.1.1 to the CPE.

At the step 302, the cable gateway will periodically send an IGMP General Query message to the CPE, asking if there are any multicast groups that the CPE subscribes to.

In some cases, one CPE may send multiple IGMP Join/Report messages to the cable gateway, as shown in steps 321, 322 and 323, to subscribe to a plurality of multicast groups, for example, 225.1.1.1, 225.1.1.2, . . . , 225.1.1.n. This may be caused by some special usage scenarios, such as software defect of the CPE, multicast malware or cyber-attack. For example, a picture in picture (PIP) function will require the CPE to join multiple groups at the same time in order to display two multicast programs simultaneously in the display screen. In another example, a CPE may have defects where it will send out all the multiple groups joined/received during a period of time when receiving the IGMP General Query message from the cable gateway.

In such cases, at the step 324 shown in FIG. 3, the cable gateway will associate the IP addresses of all multicast group requested from the CPE by adding the association between the IP address 192.168.100.10 of the CPE to all multicast group IP addresses 225.1.1.1, 225.1.1.2 to 225.1.1.n. Then at step 325, the cable gateway will send multicast data streams for all these multicast groups to the CPE, which will cause unnecessary network data flooding and congestion. As described above, the operator may set a restriction of the maximum number of TV programs for all CPEs of one cable gateway. In this case, one CPE will use up all the allocated resource of TV programs, in which case the other CPEs will not be able to watch TV normally.

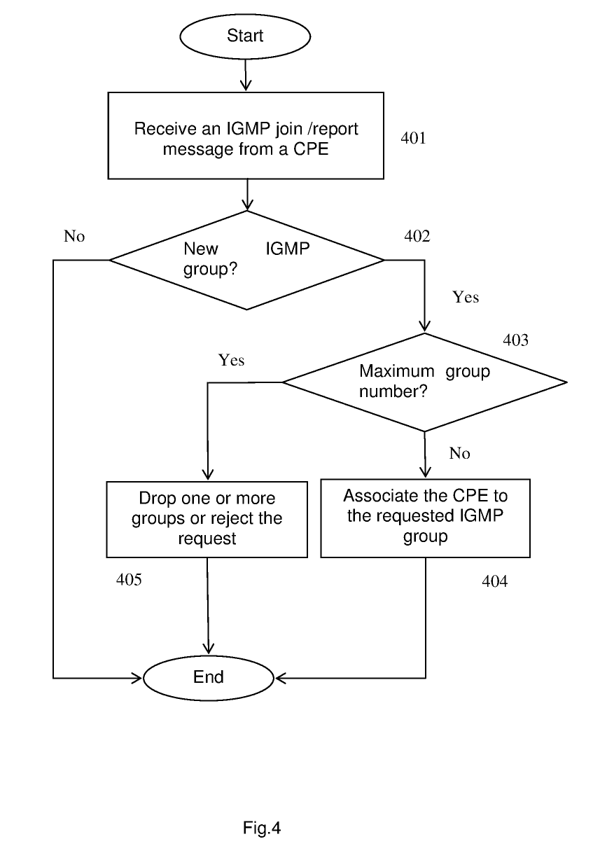

FIG. 4 is a flow chart showing an exemplary method of managing IP multicast groups of IPTV service according to an embodiment of the disclosure.

The process can be applied to the cable gateway in the network shown in FIG. 1 as a multicast router.

As shown in FIG. 4, as step 401, the cable gateway receives an IGMP join/report message from a CPE.

As step 402, the cable gateway will check whether the requested IGMP group already exists. This can be done by traversing the association for the IP address of the CPE and the multicast IP addresses of the IGMP group. If the result of step 402 is “No”, the method will proceed to an end.

If the result of step 402 is “Yes”, which means that the CPE requests for joining a new IGMP group, at step 403 the cable gateway will determine whether the number of existing associated multicast group of the CPE is equal to a maximum number of groups that the CPE can join. It can be appreciated by a person skilled in the art that the number of existing associated multicast group of the CPE can be obtained by checking the existing association between IP address of the CPE and the multicast IP addresses. The maximum number can be defined according to the operator's restriction of the maximum number of TV programs for all CPEs of one cable gateway.

If the result of step 403 is “No”, at step 404 the cable gateway will associate the IP/MAC address of the CPE with that of the requested IGMP group. Then the method will proceed to an end.

If the result of step 403 is “Yes”, at step 405 the cable gateway will drop one or more IGMP groups of the CPE or reject the request so that the number of groups that the CPE is joining does not exceed the maximum number.

The step 405 can be implemented by a drop-first policy, where the oldest entry of the associated multicast groups will be dropped. By doing this, the new IGMP group requested by the IGMP Join/Report message can be associated while the number of groups that the CPE joins will not exceed the maximum number.

The step 405 can be implemented by a drop-last policy, where the newest entry of the associated multicast group will be dropped. In this case, the cable gateway will simply ignore the new IGMP Join/Report message so that a new association is not added for the new IGMP group.

The above drop-first and drop-last policies are proposed in view of the practical application scenario described in the embodiments, which are simple to be implemented and will not cause a big increase of the complexity of the software. However, the adjustment of the IGMP groups of the IPTV client device is not limited to the above described policies. Any other policies of dropping one or more groups can be used according to the specific application context.

The adjustment can be implemented by the Simple Network Management Protocol (SNMP). That is, the cable gateway can use standard objects defined in the SNMP to specify the maximum group number and the group maintenance algorithm of the drop policy. Below is an example of a definition of the SNMP object structure.

The tchCgIGMPMaxGroupNumber is used to define the maximum number of multicast groups allowed for one CPE.

tchCgIGMPMaxGroupNumber OBJECT-TYPE

| SYNTAX | INTEGER |
|---|---|
| MAX-ACCESS read-write | |
| STATUS | current |

DESCRIPTION

“Maximum number of multicast group per CPE”

::= { tchCgIGMPRoot 1 }

tchCgIGMPGroupMaintenance OBJECT-TYPE
SYNTAX INTEGER

{

dropFirst(1),
dropLast(2)

}

MAX-ACCESS read-write

STATUS current

```
  DESCRIPTION
  “IGMP group maintenance algorithm, drop first or drop last.”
```

::= { tchCgIGMPRoot 2 }

The cable gateway can receive the concrete configuration listed in above SNMP object structure definitions 1 and 2 from the TFTP provision server of the head-end device shown in FIG. 1, for example, by a cable modem (cm) configuration file which is complied with the DOCSIS(Data Over Cable Service Interface Specification) 3.0 standard. During the process of the cable gateway registering to the CMTS, it will get the cm configuration file in binary format from TFTP server. Within this cm configuration file, the values of the tchCgIGMPMaxGroupNumber and the tchCgIGMPGroupMaintenance can be specified using SNMP MIB Object TLV11. An example of the text representation of the configuration is as below:

SnmpMibObject tchCgIGMPMaxGroupNumber Integer 2 ;
/*OID: . 1.3.6.1.4.1.2863.205.10.2.1.1*/
SnmpMibObject tchCgIGMPGroupMaintenance Integer 1;
/*OID: . 1.3.6.1.4.1.2863.205.10.2.1.2*/

The cable gateway will parse the cm configuration file, which is in Type—Length—Value (TLV) format of DOCSIS 3.0 standard during its online process. The cable gateway will extract the values of the tchCgIGMPMaxGroupNumber and the tchCgIGMPGroupMaintenance within the cm configuration file, and apply to itself. Based on the information in the cm configuration file, the process illustrated in the flow chart of FIG. 4 can be implemented at the cable gateway. Specifically, when the cable gateway receives the IGMP Join/Report message for a CPE, it will check existing association number and compare it to the configured tchCgIGMPMaxGroupNumber. Based on the result of the comparison, the drop process will be carried out based on the policy specified in the cm configuration file.

With the process of the embodiment of the disclosure, since only a preset number of IGMP groups are allowed for an IPTV client device, the risk of the system being flooded by streaming data is reduced.

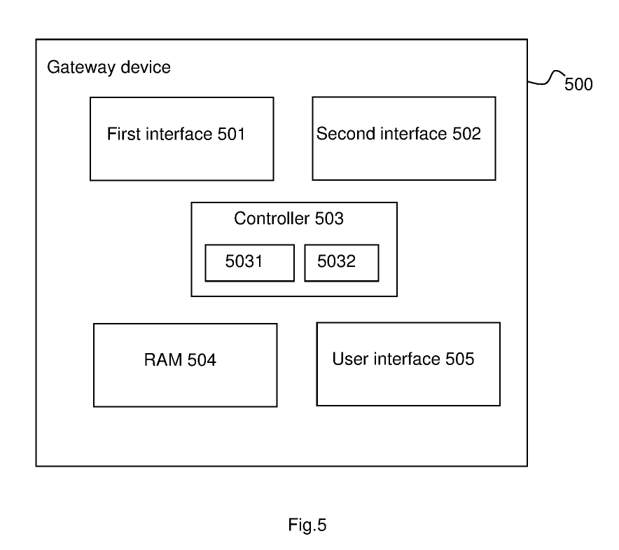

FIG. 5 is exemplary block diagram showing a gateway device 500 on which the method of managing IP multicast groups of IPTV service according to an embodiment of the disclosure can be implemented.

As shown in FIG. 5, the gateway device 500 comprises a first interface 501 for communicating with a head-end device of IPTV service over a first network. The first network can be a cable network as shown in FIG. 1. The gateway device 500 can receive multicast streaming is carried out from the head-end device on a coaxial wire.

The gateway device 500 comprises a second interface 502 for communicating with at least one IPTV client devices over a second network. As the network structure shown in FIG. 1, the IPTV client device can be a STB, a tablet, a PC or a smart phone. The gateway device 500 acts as an IGMP router for forwarding the multicast data packets from the upper layer network to the IPTV client devices which join a certain multicast address. The second network can be wired or wireless.

The gateway device 500 comprises a controller 503 for implementing the process described with reference to FIG. 4.

Specifically, the controller 503 comprises a receiving unit 5031 for receiving a request from an IPTV client device for joining a new IGMP multicast group of IPTV service.

The controller 503 further comprises an adjustment unit 5032 for adjusting IGMP multicast groups of the IPTV client device according to a preset condition as a function of the number of the IGMP multicast groups which are joined by the IPTV client device over a preset value.

The preset condition here can be implemented as the process described in the steps 404 and 405.

It can be appreciated that the gateway device 500 can also comprise a RAM memory 504 and a user interface 505 for interacting with a user.

It is to be understood that the present invention may be implemented in various forms of hardware, software, firmware, special purpose processors, or a combination thereof. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software program, the actual connections between the system components (or the process steps) may differ depending upon the manner in which the present disclosure is programmed. Given the teachings herein, one of ordinary skill in the related art will be able to contemplate these and similar implementations or configurations of the present disclosure.

1. A method to manage multicast groups of streamed multimedia data comprising:
receiving a request from a client device to join a new multicast group of a streamed multimedia data service; and
adjusting multicast groups of the client device according to a preset condition as determined by a number of the multicast groups which were previously joined by the client device over a value.

2. The method according to claim 1, wherein the streamed multimedia data service is an Internet Protocol Television (IPTV) service and the method is for managing a multicast grouping of the IPTV service according to an Internet Group Management Protocol (IGMP).

3. The method according to claim 2, wherein the adjustment further comprises:
associating the IP(Internet Protocol)/MAC(Media Access Control) address of the client device with the IP/MAC address of the new multicast group if the number of said multicast groups is not equal to the value.

4. The method according to claim 2, wherein the adjustment further comprises:
ignoring said request if the number of said multicast groups is equal to the value.

5. The method according to claim 2, wherein the adjustment further comprises:
dropping one or more multicast groups which are joined by the client device and associating the IP/MAC address of the client device with the IP/MAC address of the new multicast group if the number of said multicast groups is equal to the value.

6. The method according to claim 5, further comprising:
dropping an oldest one of said multicast groups.

7. The method according to claim 2, wherein said adjustment is implemented by definitions in a Simple Network Management Protocol (SNMP).

8. A device comprising a first interface to communicate with a head-end device of multimedia data service over a first network and a second interface to communicate with at least one client devices over a second network, for delivering at least one multicast group of multimedia data service from the head-end device to the client device, it further comprises a controller comprising:
a receiving unit to receive a request from one of the at least one client devices for joining a new multicast group of multimedia data service; and
an adjustment unit to adjust multicast groups of said client device according to a preset condition as determined by a number of the multicast groups which were previously joined by the client device over a value.

9. The device according to claim 8, wherein the device is a gateway for delivering data of an Internet Protocol Television (IPTV) service to the at least one client devices according to an Internet Group Management Protocol (IGMP).

10. The device according to claim 9, wherein the adjustment unit associates the IP/MAC address of said client device with the IP/MAC address of the new multicast group if the number of said multicast groups is not equal to the value.

11. The device according to claim 9, wherein the adjustment unit ignores said request if the number of said multicast groups is equal to the value.

12. The device according to claim 9, wherein the adjustment unit drops one or more IGMP multicast groups which are joined by said client device and associates the IP/MAC address of said client device with the IP/MAC address of the new multicast group if the number of said multicast groups is equal to the value.

13. The device according to claim 12, wherein the adjustment unit drops an oldest one of said multicast groups.

14. The gateway device according to claim 8, wherein the first network is a cable network.

15. The gateway device according to claim 8, wherein the second network is a wireless network.
